(19) United States
(12) Patent Application Publication
(10) Pub. No.: US 2015/0097829 A1
(43) Pub. Date: Apr. 9, 2015

(54) 3D Modeling Using Unrelated Drawings

(71) Applicant: Cherif Algreatly, Newark, CA (US)

(72) Inventor: Cherif Algreatly, Newark, CA (US)

(73) Assignee: Cherif Atia Algreatly, Newark, CA (US)

(21) Appl. No.: 14/279,344

(22) Filed: May 16, 2014

Related U.S. Application Data
(60) Provisional application No. 61/961,306, filed on Oct. 9, 2013.

(51) Int. Cl. G06T 17/10

(52) U.S. Cl. CPC G06T 17/10
USPC 345/420

(57) ABSTRACT

A method is disclosed to create a 3D model using unrelated drawings. The unrelated drawing may represent the top view, front view, and side view of the 3D model. A user can draw on a computer display to automatically generate the 3D model in real time. The user can also draw on a piece of paper using a pencil, and capture the picture of the drawing using a mobile phone camera to display the 3D model on the mobile phone screen. The drawing can be outlines extracted form a picture of a building, object, natural element or creature using a computer vision program. various designers in designing innovative buildings, products, furniture, vehicles, machines, jewelry, cartoons, or the like.

### CROSS-REFERENCE TO RELATED APPLICATION

This application claims the benefits of a U.S. Provisional Patent Application No. 61/961,306, filed Oct. 9, 2013.

### BACKGROUND

Creating a 3D model is an exceptional way to visualize any design concept that a designer can dream up. The designer can document or develop this design concept further using the image produced on the computer display. In most cases, having an undocumented concept means that the details of the concept are not fully clear to others or even to the designer. Thus, transforming a design concept into a virtual 3D model can be valuable to everyone. This need for effective, illustrative 3D models applies to almost every design field, including building design, industrial design, furniture design, vehicle design, mechanical design, jewelry design, and cartoon design for filmmaking.

Many of the commercially available software applications for 3D modeling cannot help a user in the early brainstorming design phase of a concept. Requiring the user to construct each part of a 3D model frustrates the designer, especially if s/he does not have a clear idea about his/her design details. In most cases, the designer can imagine incomplete 2D drawings for different faces of the 3D model, such as the top, front, and side views. These incomplete drawings do not always fit or match each other, and accordingly, using them to create a 3D model using traditional software applications is impossible. In fact, in many cases these 2D drawings can be easily expressed using pencil and paper since the user's freehand sketch can be considerably faster than any software in presenting the first design concept.

An innovative software application that transforms unclear design concepts in a user's head into professional 3D models, quickly and intelligently, would be greatly welcomed. This innovative software application should automatically turn any two or more 2D drawings, representing different views of a 3D model, into a perfect 3D model regardless of the missing dimensions or whether the 2D drawings match/fit one another. Once the user changes one of the 2D drawings, the 3D model automatically and simultaneously changes as well. In other words, this desired software application helps eliminate the time difference between the initial envisioning of a design concept in the user's head and the slow speed of constructing this design concept into a 3D model. Accordingly, the user's brain storming process is enhanced, and the imaginary designs of the user are turned into visual 3D models quickly in real time.

### SUMMARY

The present invention resolves the aforementioned problem by disclosing a method of 3D modeling that automatically turns an incomplete design concept into a professional 3D model. The user can draw two or more 2D drawings, representing two or more faces of a 3D model, without providing dimensions or alignment between the drawings to simultaneously generate a professional 3D model. For example, a first drawing representing the top view of an object and a second drawing representing a front view of the object can be automatically combined with each other to create the 3D model of the object. Also, a first drawing representing a front view of an object and a second drawing representing a side view of the object can be automatically combined to create a 3D model of the object. A first drawing representing a top view of an object, a second drawing representing a front view of the object, and a third drawing representing a side view of the object can all be automatically combined with each other to create the 3D model of the object.

The method of the present invention does not require the user to provide dimensions, details, or an accurate alignment between the lines of the different drawings or views. For example, the width of the top view does not have to match the width of the front view. Also, the height of the front view does not have to match the height of the side view. The present method does not constrain or reject any drawings that the user provides, even when the drawings do not make sense. Accordingly, all kinds of drawings provided by the user are automatically converted into professional 3D models. Changing any line in the top, front, or side view automatically creates a new 3D model corresponding to the changes that the user made. Any deleting or adding of one or more geometrical shapes in the top, front, or side view simultaneously changes the 3D model on the computer display. Accordingly, the user can create and explore hundreds of different 3D models in minutes with minimum input on the user's part.

In one embodiment of the present invention, the user uses a computer input device such as a computer mouse or touchscreen to draw the top, front, and/or side views of the 3D model. In another embodiment, the user draws the top, front, and/or side views on a piece of a paper using a regular pencil, then captures the picture of these freehand drawings to automatically create the 3D model. In this case, the user can use the digital camera of a mobile phone or tablet to present the 3D model on the mobile phone screen or tablet screen. In one embodiment, the user can modify the drawing to simultaneously create a new 3D model corresponding to the user's modifications. Modifying the drawing can be done in a variety of simple ways, for example, the user can stretch or compact the total width of a drawing relative to the total depth of the same drawing or vice versa. This little input or action on the user's part alters the 3D model. The user can also rotate one of the top, front, or side views to completely change the 3D model according to this rotation. The user can also move, increase or decrease the size of one or more geometrical shapes of the top, front, or side view to dramatically change the 3D model.

In another embodiment, the user can generate multiple 3D models with one set of 2D drawings or views. For example, the user can draw top and front views to automatically create a first 3D model. After that, the user makes some changes to the top view or the front view to automatically create a second 3D model. The first 3D model can then be gradually converted into the second 3D model using some form of animation presented on the computer display. During the animation, hundreds of different 3D models are generated to gradually convert the first 3D model into the second 3D model. At any moment the user can stop the animation to select one of the hundreds of presented 3D models that suits the design concept. The main advantage of this technique is creating a large quantity of different 3D models in a very short time, without the user needing to think up and design specifically all these 3D models.

The method of the present invention is perfect for users who would like to create and explore various design options with a few details they have in mind. It is also a powerful presentation tool to swiftly convert a set of 2D drawing into a professional 3D model. Moreover, the present method is simple enough to be used and understood by practically anyone who would like to create a 3D model and print it with a 3D printer, without having to learn a complicated software application for 3D modeling. Generally, the present invention serves various designers and 3D modelers in their imagining and creating of buildings, products, furniture, vehicles, machines, jewelry, and movie cartoons.

Overall, the above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF DRAWINGS

FIG. 1 illustrates a graphical user interface (GUI) which divides a computer screen into a first part assigned to a top view, a second part assigned to a front view, a third part assigned to a side view, and a fourth part assigned to a 3D model.

FIG. 2 illustrates drawing a top view in the first part and a front view in the second part to automatically generate a 3D model corresponding to the top and front views.

FIG. 3 illustrates dividing the top view into first sections at each start point and end point of a horizontal line.

FIG. 4 illustrates dividing the front view into second sections at each start point and end point of a horizontal line.

FIG. 5 illustrates resizing the width of the front view to match the width of the top view to combine the first sections with the second sections.

FIG. 6 illustrates combining the first sections with the second sections to create collective sections.

FIG. 7 illustrates the wireframe of the 3D model as a result of connecting each two successive sections of the collective sections.

FIG. 8 illustrates drawing a top view in the first part and a side view in the third part to automatically generate a 3D model corresponding to the top and side views

FIG. 9 illustrates combining the sections of the top view and side view to generate collective sections, after resizing the height of the side view to match the depth of the top view.

FIG. 10 illustrates drawing a front view in the second part and a side view in the third part to automatically generate a 3D model corresponding to the top and side views

FIG. 11 illustrates combining the sections of the front view and side view to generate collective sections, after resizing the height of the side view to match the height of the front view.

FIG. 12 illustrates modeling the collective sections in three dimensions based on the sections of the front view and side view.

FIG. 13 illustrates the wireframe of the 3D model as a result of connecting each two successive sections of the collective sections.

FIGS. 14-19 illustrate examples of 3D models automatically created by combining two of a top view, front view, and side view with each other.

FIGS. 20 and 23 illustrate combining a top view, front view, and side view with each other to automatically create a 3D model.

FIG. 24 illustrates an example of a 3D model comprised of multiple parts, each of which was independently created by the method of the present invention.

FIG. 25 illustrates automatically creating a 3D model by combining a front view and side view in the form of text.

FIGS. 26-30 illustrate adding some geometrical shapes to text to change the shape of the 3D model.

FIGS. 31 and 34 illustrate four examples of rotating a top view with different angles to change the 3D model accordingly.

### DETAILED DESCRIPTION OF INVENTION

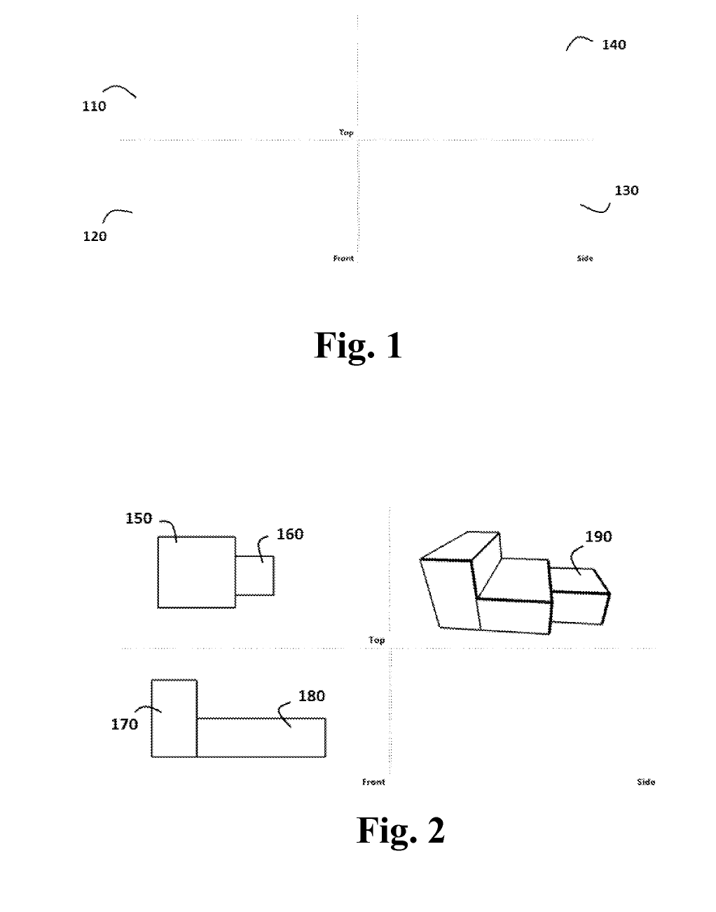

FIG. 1 illustrates a graphical user interface (GUI) that divides a computer display into a first window 110 assigned for a drawing representing the top view of an object, a second window 120 assigned for a drawing representing a front view of the object, a third window assigned for a drawing representing a side view of the object, and a fourth window 140 assigned for the 3D model of the object that is automatically generated as a result of combining the top view, the front view, and the side view. FIG. 2 illustrates drawing a top view in the form of a first square 150 and second square 160, as well as, drawing a front view in the form of a first rectangle 170 and second rectangle 180. Once the top view and the front view are drawn by a user, a 3D model 190 corresponding to the top and front views is automatically generated on the computer display.

As shown in the figure, the width of the top view does not match the width of the front view, while the 3D model is automatically generated regardless of the unmatched widths or dimensions of the drawings. To achieve this, the present invention discloses four technical steps. The first step is to vertically divide the top view into first sections, and also to vertically divide the front view into second sections, at each start point and end point of a horizontal line. The second step is to resize the width of the top view or the front view to match the other. The third step is to combine the first sections and the second sections to generate what is called collective sections. The fourth step is to assign a width and height for each collective section from a corresponding first section and second section to create the 3D model.

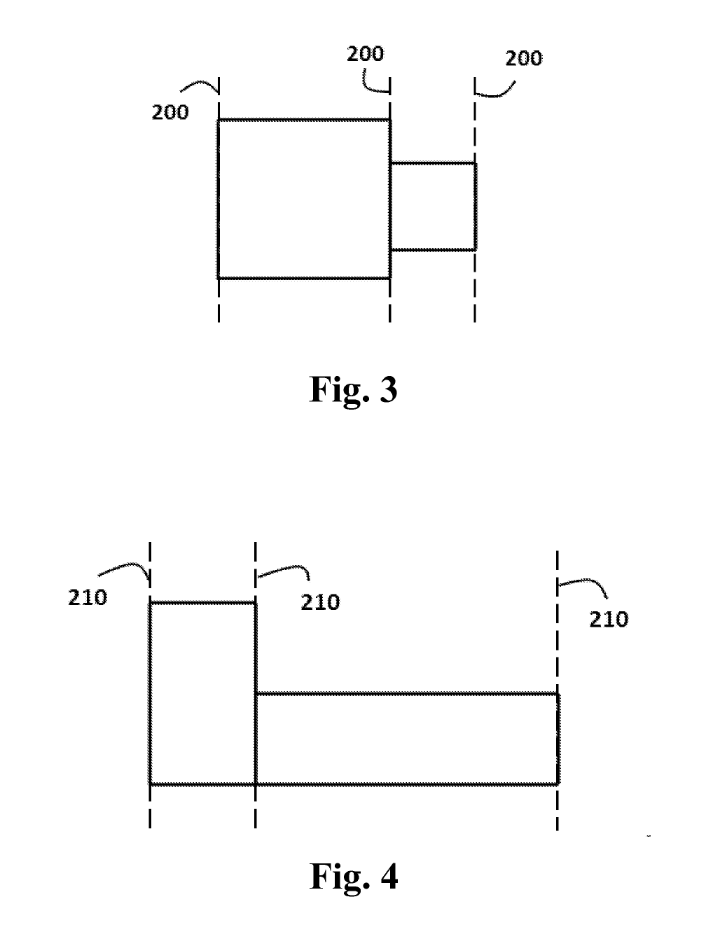

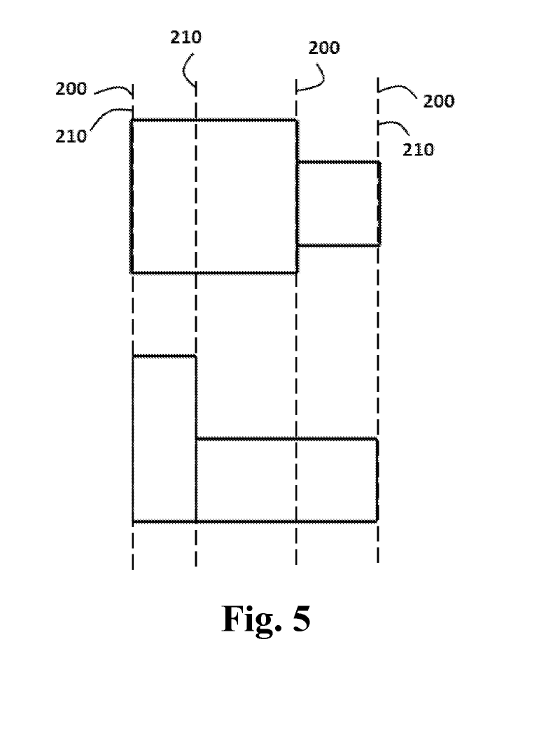

To clarify these four technical steps, FIG. 3 illustrates vertically dividing the top view into first sections 200 at each start point and end point of a horizontal line. Also, FIG. 4 illustrates dividing the front view into second sections 210 at each start point and end point of a horizontal line. FIG. 5 illustrates resizing the width of the front view to be equal to the width of the top view, then combining the first sections and the second sections to generate the collective sections that include both of the first sections 200 and second sections 210. As shown in the figure, each of the left and right sections of the collective sections includes one of the first sections and one of the second sections, while all other sections of the collective sections include one of the first sections or one of the second sections.

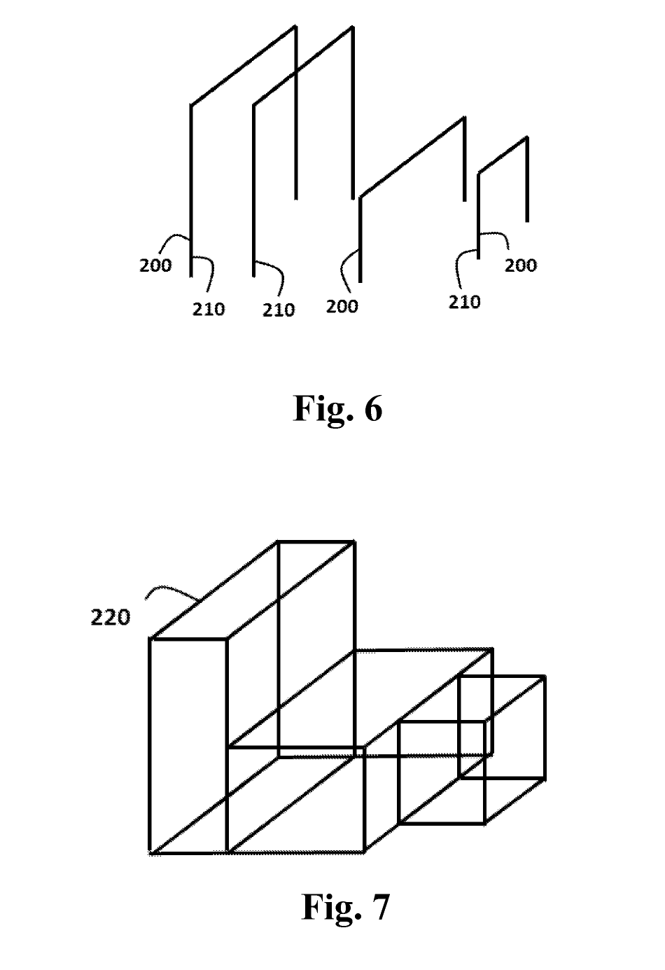

At this stage, the width of each part of a collective section is determined from a corresponding first section. Also, the height of each part of a collective section is determined from a corresponding second section. This leads to representing the collective sections in three-dimensions in FIG. 6. As shown in FIG. 7, connecting each two successive sections of the collective sections generates the wireframe 220 of the 3D model. Adding surfaces to the wireframe generates the 3D model shown in FIG. 2. Generally, it is important to note that the method of the present invention does not require the user to provide drawings that have anything in common between each other. This includes common dimensions, alignment, number of objects or geometrical shapes, or the like. Accordingly, any drawings representing top view, front view, and/or side view can be automatically converted into a 3D model. This advantage enables the user to create a 3D model from unrelated drawings, which eliminates any input restriction, and facilitates the creation process of the 3D models.

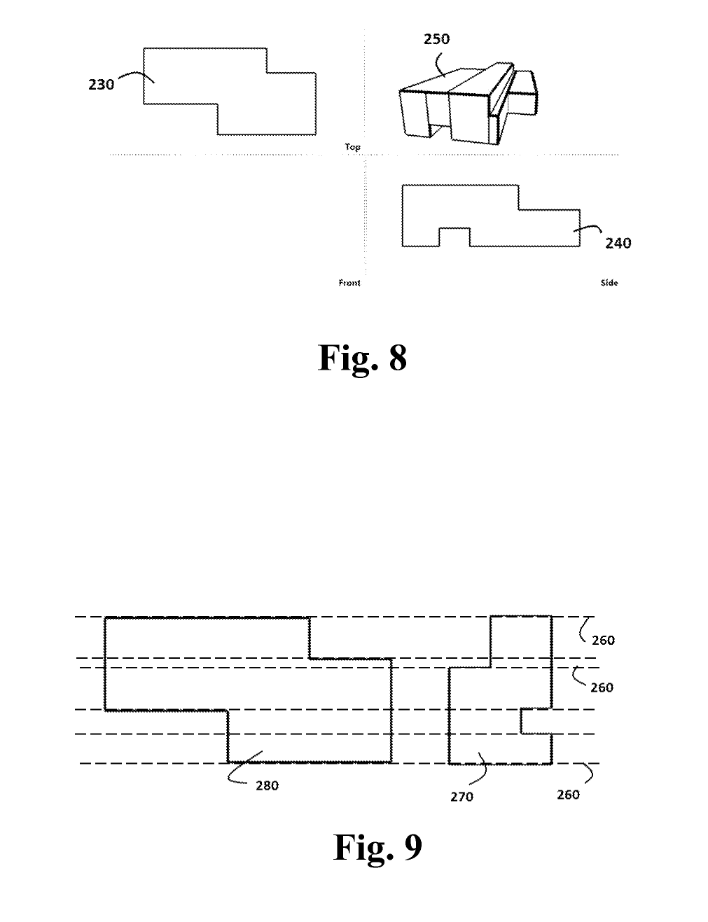

The same method of combining a top view and front view to automatically generate a 3D model can be used to combine a top view and side view, or a front view and side view to create a 3D model. For example, FIG. 8 illustrates combining a top view in the form of a first polygon 230 with a side view in the form of a second polygon 240 to automatically generate a 3D model 250. As shown in the figure, the depth of the top view does not match the width of the side view. Accordingly, the depth of the top view or the width of the side view is resized to match the other. After that, the top view is horizontally divided into first sections at each start point and end point of a vertical line. Also, the side view is vertically divided into second sections at each start point and end point of a horizontal line. FIG. 9 illustrates combining the first sections and the second sections to generate the collective sections 260 after aligning the width of the second polygon 270 with the depth of the first polygon 280, as shown in the figure.

In this figure, it is important to note that the side view is rotated 90 degrees to be aligned to the depth of the top view. This is opposite to the front view, where its width can be aligned to the width of the front view without rotation. However, once the collective sections are generated, the details of each collective section are determined from the corresponding first section of the top view and/or the corresponding second section of the side view to create the wireframe of the 3D model. Once the wireframe is created, the 3D model is generated by adding surfaces to the wireframe, as was descried previously.

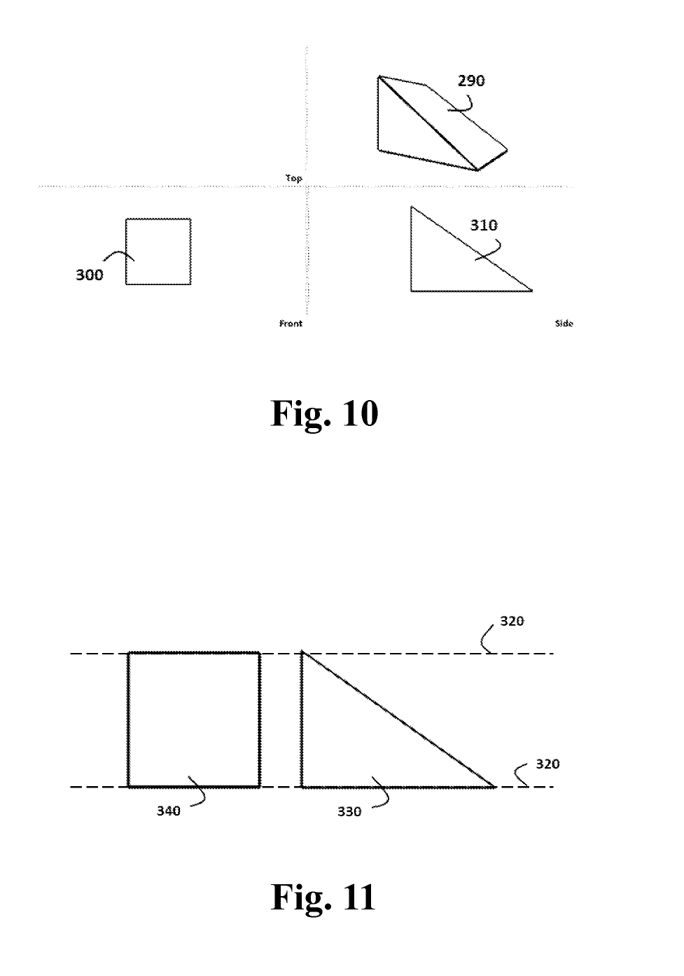

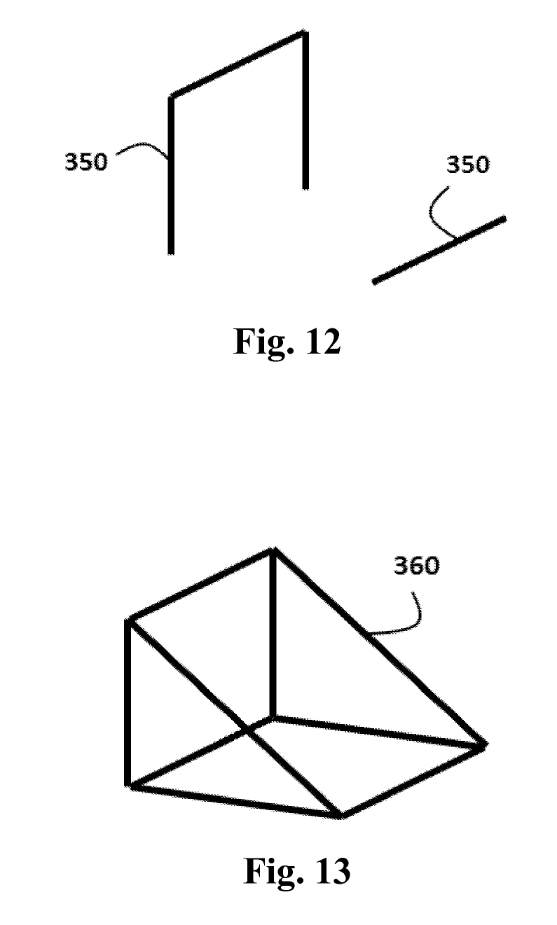

FIG. 10 illustrates another example of a 3D model 290 automatically created by drawing a front view in the form of a square 300 and a side view in the form of a triangle 310. As shown in the figure, the heights of the front view and the side view do not match each other. Accordingly, the height of the front view or the side view is resized to match the other. After that, the front view is divided with first sections at each start point and end point of a vertical line. Also, the side view is divided with second sections at each start point and end point of a vertical line. FIG. 11 illustrates combining the first sections with the second section to generate the collective sections 320. This is done by aligning the height of the side view 330 to the height of the front view 340, after resizing the height of the side view to match the height of the front view. FIG. 12 illustrates presenting the collective sections 350 in three dimensions after obtaining the details of the height and width of each collective section from a corresponding first section and/or second section. FIG. 13 illustrates the wireframe 360 of the 3D model as a result of the collective sections. Covering the wireframe with surfaces creates the 3D model of FIG. 10.

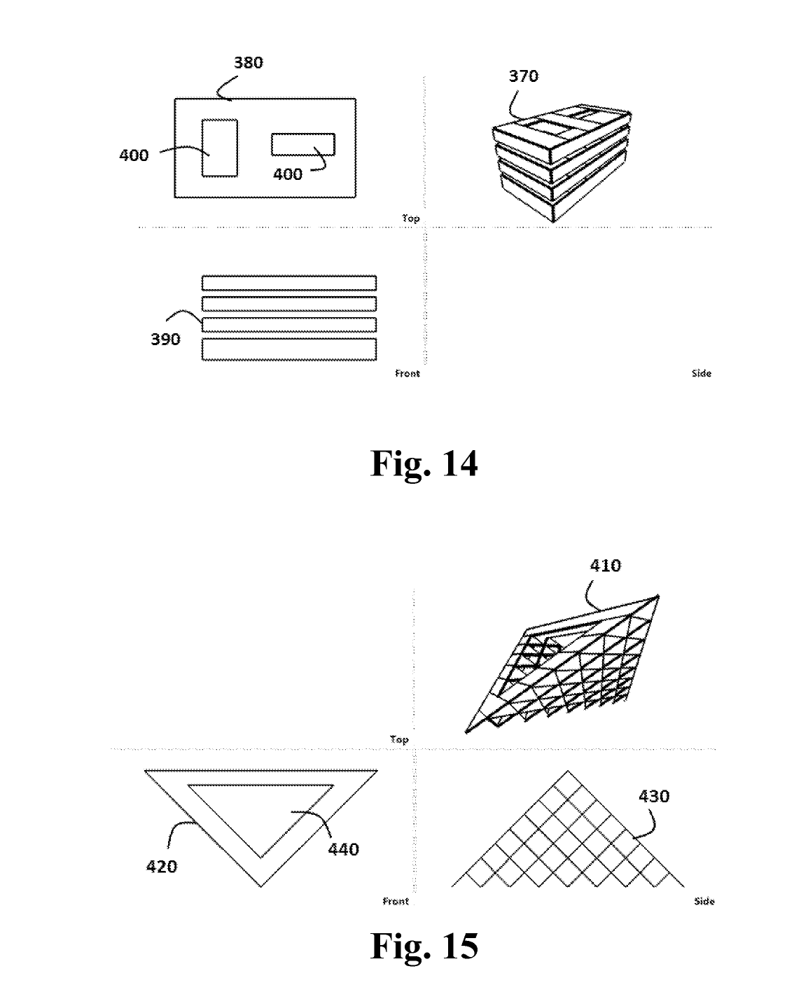

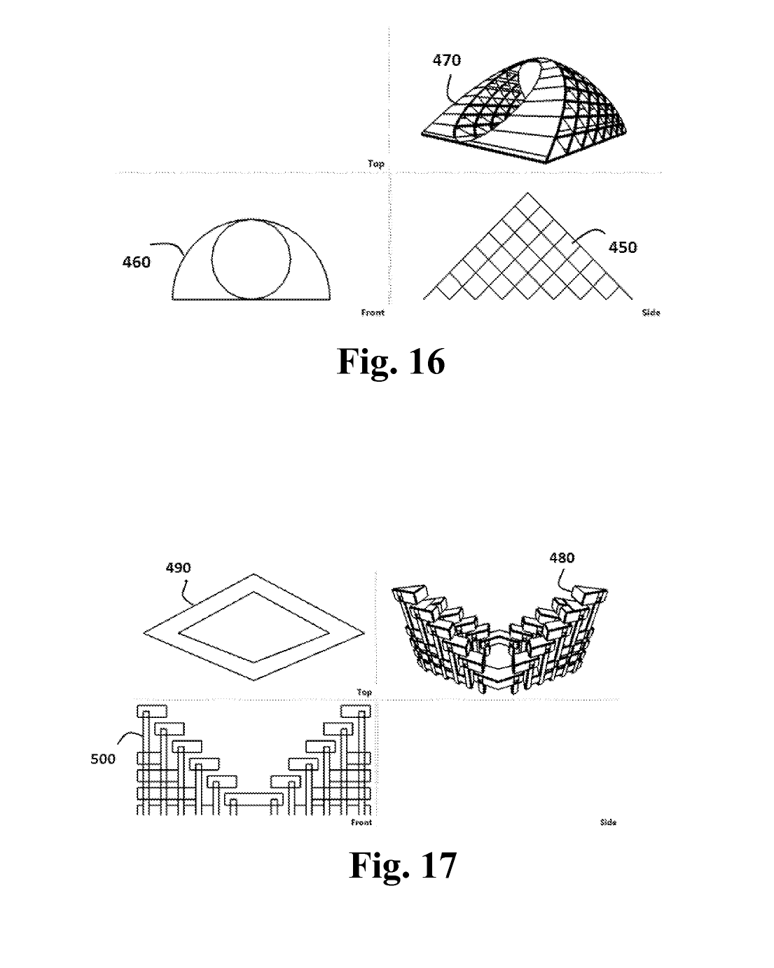

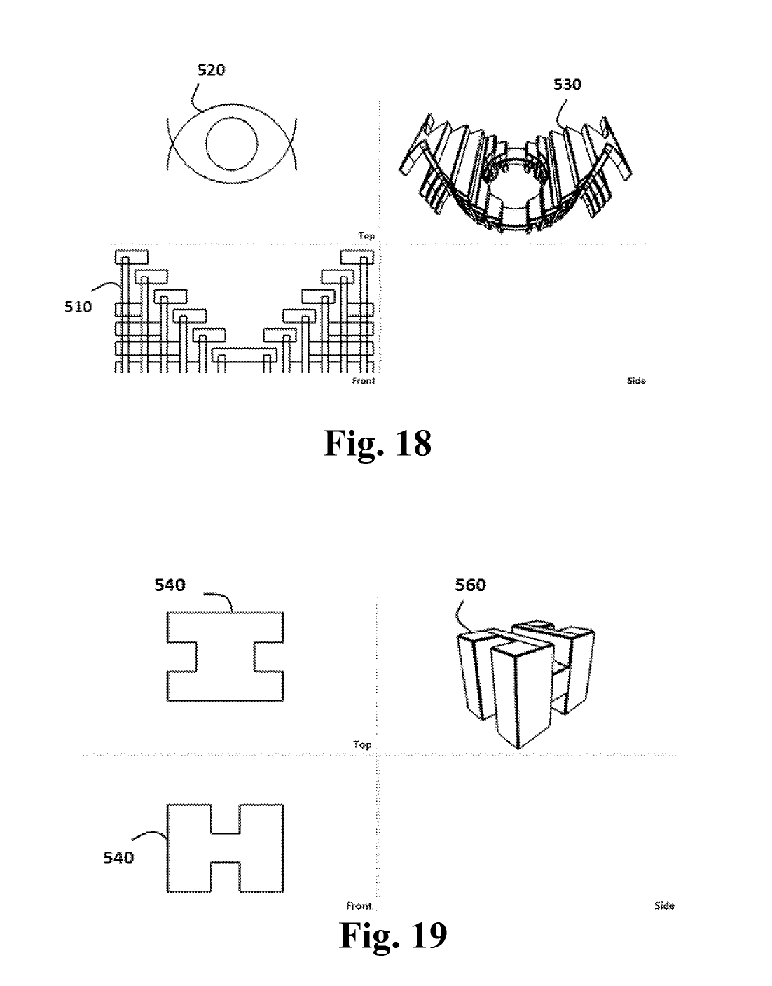

FIG. 14 illustrates a 3D model 370 automatically created to correspond to a top view 380 and a front view 390 drawn by a user. The top view includes some voids 400 that appear in the 3D model. The front view is comprised of a plurality of separated rectangles that also appear in the 3D model. FIG. 15 illustrates another example of a 3D model 410 created by combining a front view 420 and a side view 430 that were drawn by a user. The front view is in the form of a triangle with a void 440, and the side view is in the form of a plurality of squares attached to each other, where some voids are located between the squares. FIG. 16 illustrates the same side view 450 of the previous example but with another front view 460. The side view and the front view are combined together to automatically create a new 3D model 470. FIG. 17 illustrates another example of a 3D model 480 created by combining a top view 490 and a front view 500. As shown in the figure, the exact details of the front view are represented in the 3D model. FIG. 18 illustrates the same front view 510 of the previous example combined with a different top view 520 to create another 3D model 530.

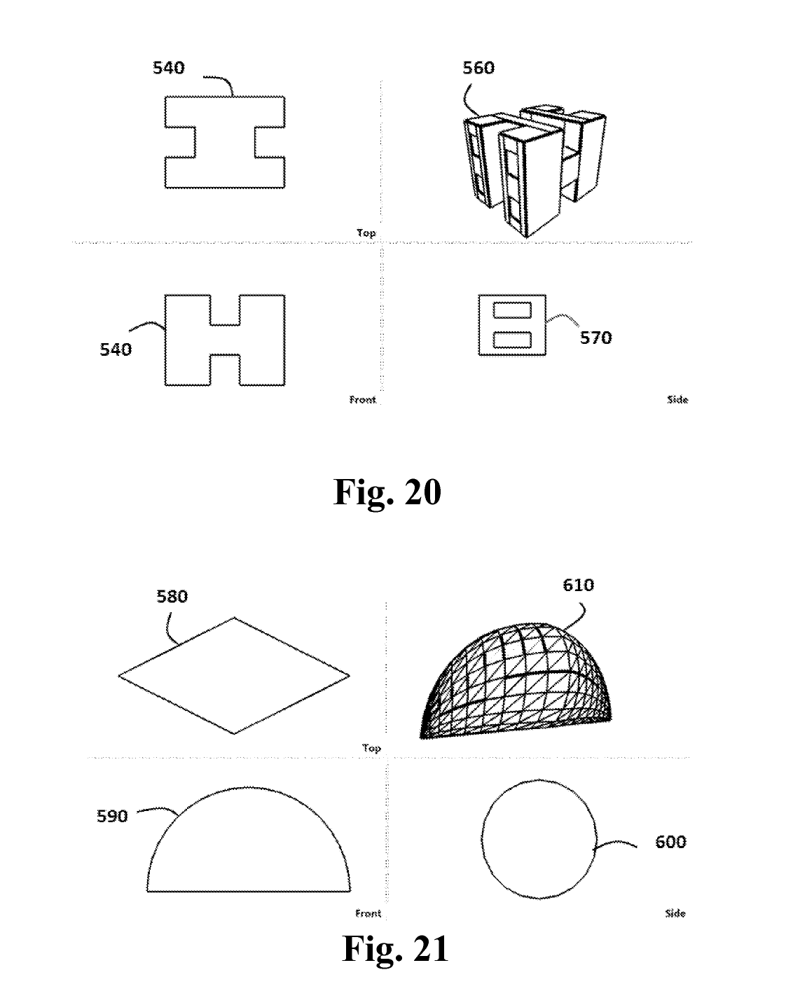

FIG. 19 illustrates a top view 540 and a front view 550 that are combined together to automatically create a 3D model 560. FIG. 20 illustrates adding a side view 570 to the same top view and front view of the previous example. As shown in the figure, the geometrical shapes of the side view appear on the side surfaces of the 3D model. This is done by locating the geometrical shapes of the side view on each side polygon of the wireframe of the 3D model at each collective section. FIG. 21 illustrates another example of combining a top view 580, a front view 590, and a side view 600 to automatically create a 3D model 610. As shown in the figure, the circle of the side view is repeated at each collective section of the wireframe of the 3D model after resizing the circle into an ellipse to match the dimensions of the collective sections. FIG. 22 illustrates an example of combining another top view 620, front view 630, and side view 640 to automatically create a 3D model 650. In this example, the side view is in the form of four separated rectangles which divides each collective section into four separated parts to make the 3D model appear as four parts separated from each other.

In the previous examples, the top view and the front view are combined with each other, and after that the side view is repeated at each collective section. However, it is possible to first combine the top view with the side view, and after that the front view is repeated at each collective section. Also, it is possible to first combine the front view with the side view, and after that the top view is repeated at each collective section. Applying each one of these three cases or alternatives to the same top view, front view, and side view generates a different 3D model.

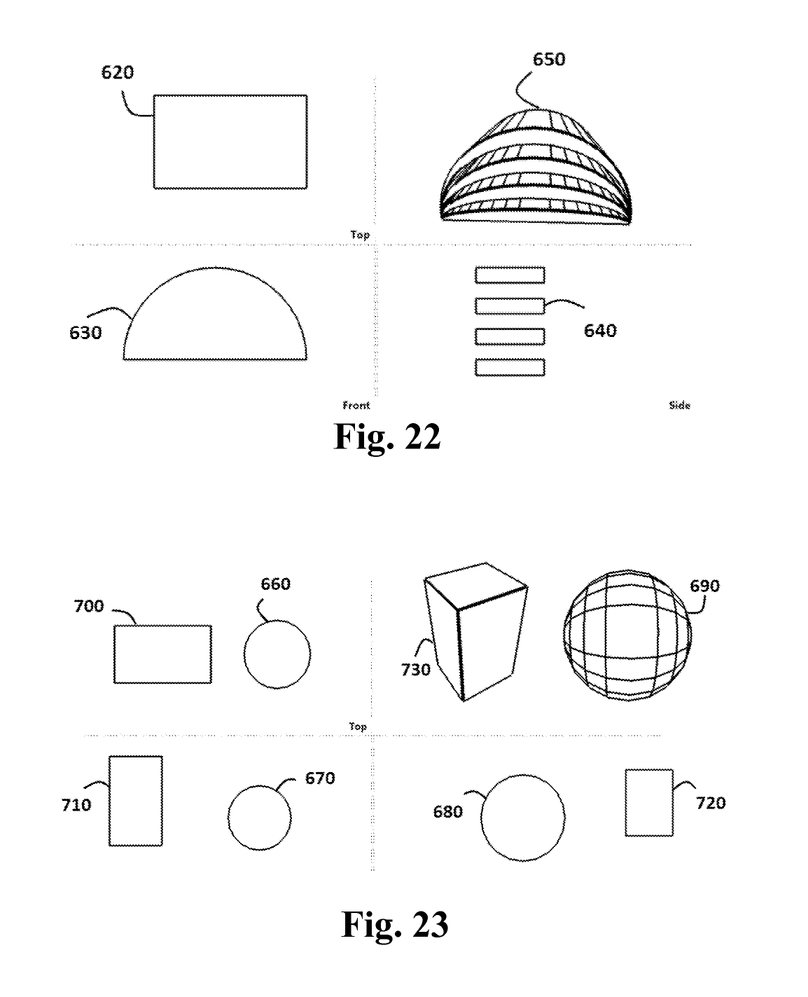

In one embodiment, the method of the present invention combines the entire geometrical shapes of the top view, front view, and side view with each other. However, in another embodiment of the present invention, the geometrical shapes of the top view, front view, and side view are separately combined with each other. For example, FIG. 23 illustrates a first circle 660, a second circle 670, and a third circle 680 that successively appear in the top view, front view, and side view windows, where these three circles are associated with each other to create a 3D model of a sphere 690. Also, FIG. 23 illustrates a first rectangle 700, a second rectangle 710, and a third rectangle 720 that successively appear in the top view, front view, and side view windows, where three rectangles are associated with each other to create a 3D model of a prism 730.

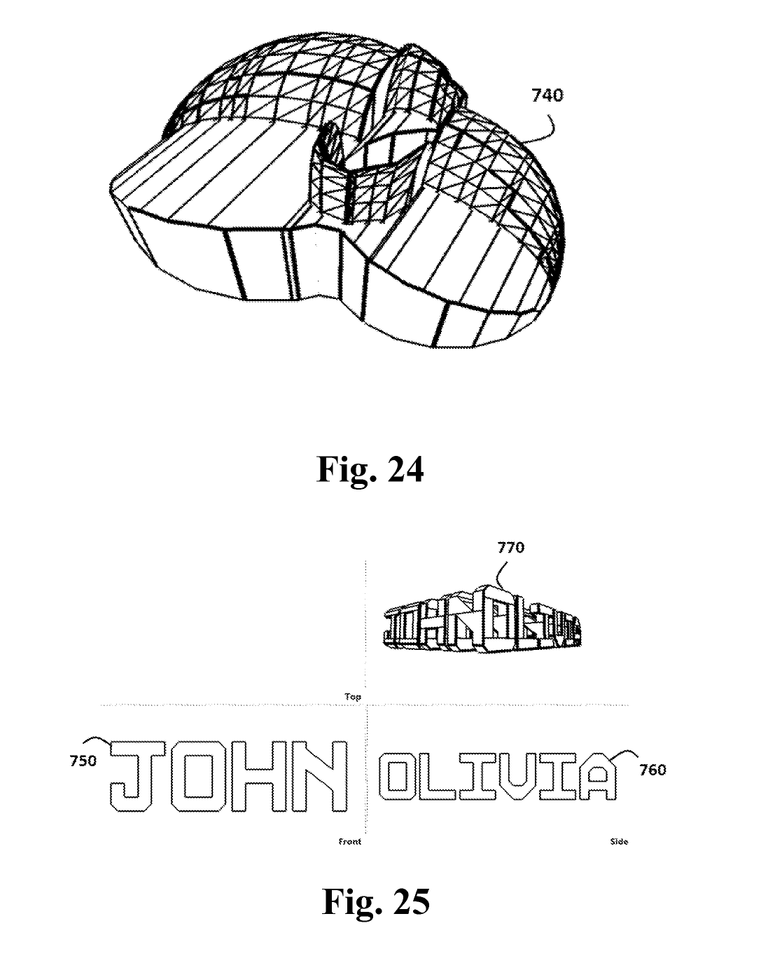

This method of separating the geometrical shapes of the drawings is useful in creating complex 3D models that are hard to be represented in one combined drawing of a top view, front view, or side view. FIG. 24 illustrates an example of a complex 3D model 740 that was created by separating the geometrical shapes of the top view, front view, and side view. As can be seen in this example, the surface curvatures of this 3D model are difficult to represent in the user's drawings of the top view, front view, or side view. Accordingly, creating this 3D model by separating the geometrical shapes of its drawings simplifies the user's input and the creation process of such a complex 3D model.

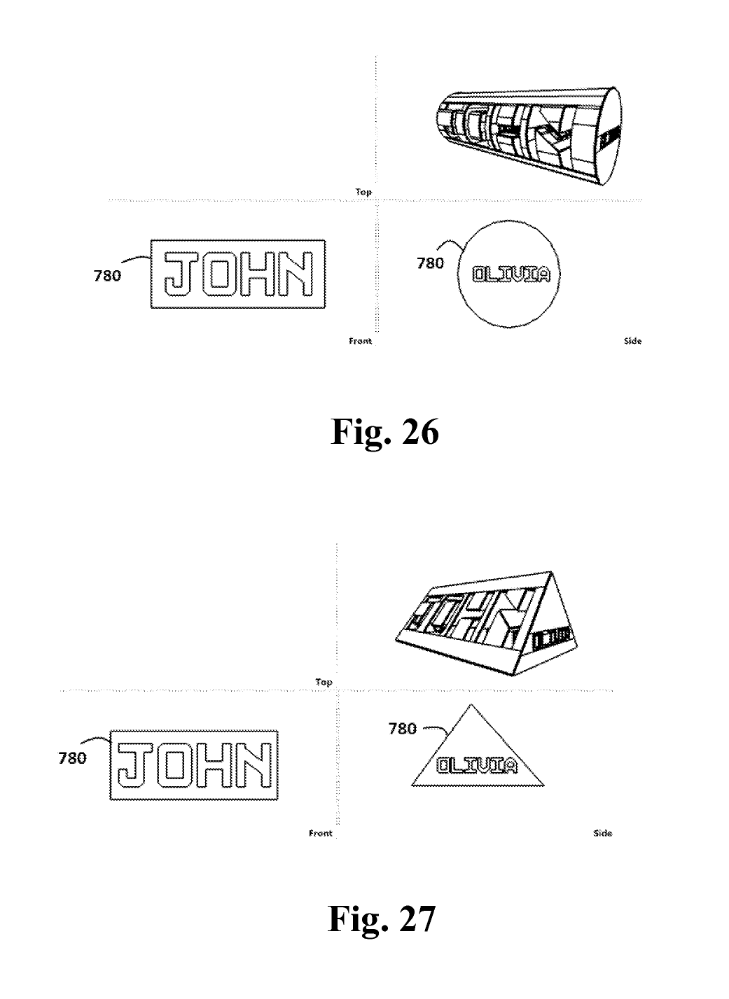

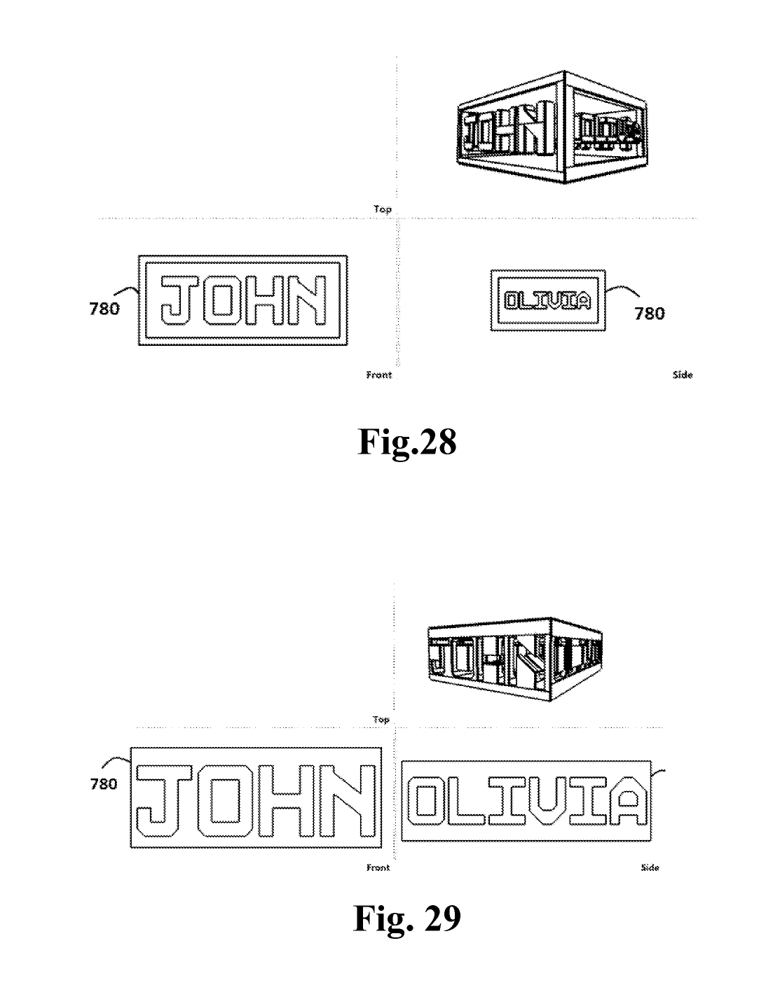

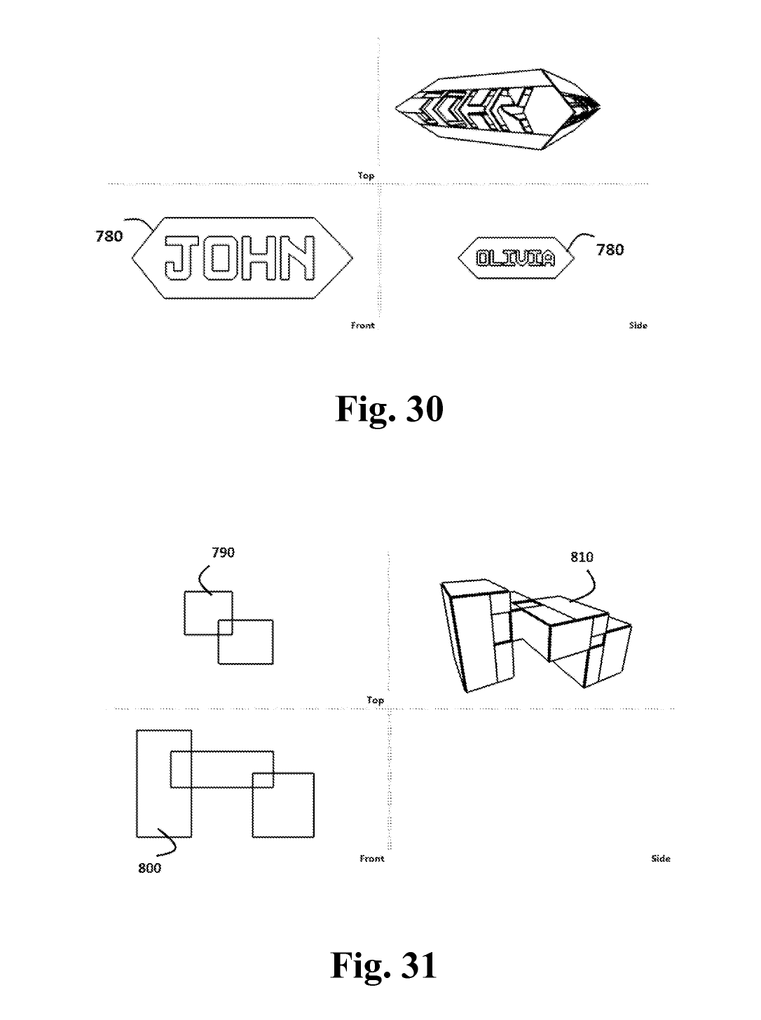

The previous examples illustrate creating 3D models using drawings representing geometrical shapes. However, it is possible to apply the same method on drawings representing text. For example, FIG. 25 illustrates a front view 750 in the form of a male name “John”, and a side view 760 in the form of a female name “Olivia”. The 3D model 770 is automatically generated to combine the two texts or names of the front view and the side view. As shown in this figure, one side of the 3D model represents the text of the front view, and the other side of the 3D model represents the text of the side view. FIGS. 26-30 illustrate adding some drawings or geometrical shapes 780 to the text of the front view and the side view, while the 3D model in each example is changed to correspond to these drawings.

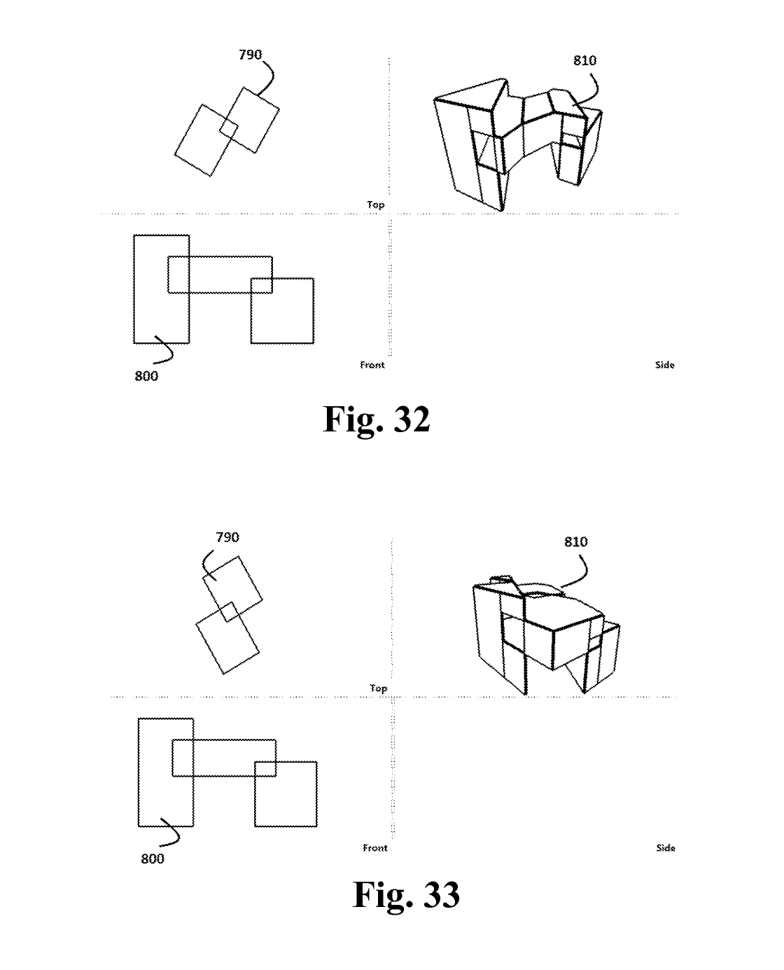

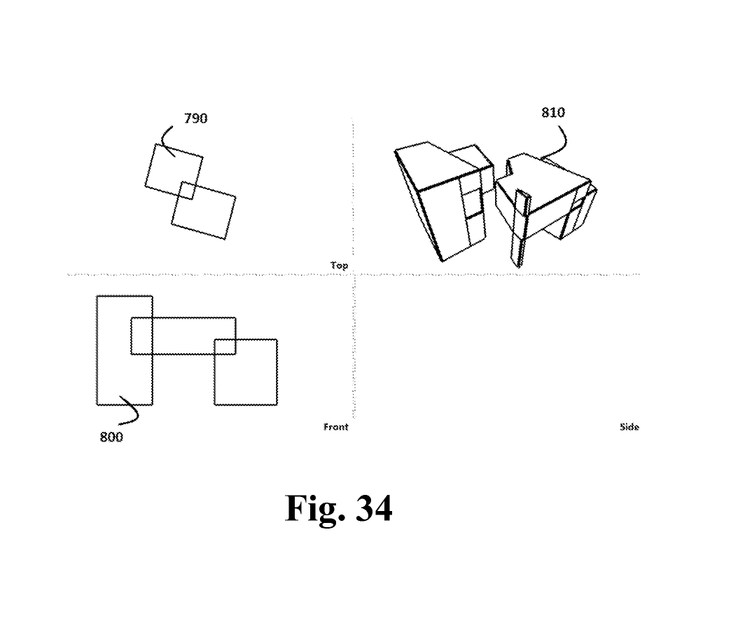

As previously mentioned, any change to the drawings of the top view, front view, and/or side view changes the 3D model. However, rotating one of the top view, front view, and side view completely changes the 3D model. For example, FIG. 31 illustrates a top view 790 and a front view 800 combined together to automatically create a 3D model 810. In FIGS. 32-34 the top view is rotated in different angles, where each different rotation changes the shape of the 3D model. Generally, rotating each one of the top view, front view, and side view creates a new 3D model. Accordingly, simultaneously rotating the top view, front view, and side view of the same set of drawings creates hundreds of different 3D models. This method is perfect for the brain storming process, since s/he can select one of these hundreds 3D models to use or modify.

As was described previously, in one embodiment of the present invention, the drawings of the top view, front view, and side view are successive projections of a 3D model on the xy-plane, the xz-plane, and yz-plane. In another embodiment, the drawings represent projections of a 3D model on planes other than the xy, xz, and yz-planes. In one embodiment of the present invention, the drawings represent cross sections of a 3D model. In yet another embodiment, the drawings used in creating a 3D model are freehand drawings or sketches drawn by a user on a piece of paper using a regular pencil. A digital camera is used to capture the picture of the freehand drawings, and a software program converts the freehand drawings into a vector graphics format to implement the method of the present invention and create the 3D model. The digital camera can be a camera of a mobile phone or tablet and the 3D model can then be presented on the mobile phone screen or tablet screen.

As was mentioned previously, the user can modify the drawings to simultaneously change the parts of the 3D model that correspond to the altered drawings. Modifying the drawings can be done in a variety of simple ways. For example, the user can increase or decrease the total width or depth of a drawing to change the 3D model accordingly. The user can also reposition one or more geometrical shapes of a drawing to simultaneously change the 3D model. Modifying the drawings involves rotating the top view, front view, or side view as was described previously. These little modifications on the user's part can dramatically change the 3D model.

Finally, it is important to state that the drawings used in creating 3D models can be extracted from a picture of buildings, objects, or natural elements or creatures. For example, a picture of a façade of an existent building can be used to represent a front view, while a picture of a tree leave can be used to represent a top view. Combining the outlines of the façade with the outlines of the tree leaf automatically creates a 3D model representing the façade and the tree leaf. In this case, a computer vision program, as known in the art, is utilized to extract the outlines that represent the façade and the tree leaf from the pictures

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A method that converts unrelated drawings into a 3D model by resizing and dividing the unrelated drawings into sections to generate the wireframe that represents the 3D model.

2. The method of claim 1 wherein the unrelated drawings have dimensions that do not match each other.

3. The method of claim 1 wherein the unrelated drawings represent the top view, front view, and side view of the 3D model.

4. The method of claim 1 wherein the unrelated drawings represent projections of the 3D model on planes other than the xy, xz, and yz-planes.

5. The method of claim 1 wherein the unrelated drawings represent cross sections of the 3D model.

6. The method of claim 1 wherein the unrelated drawings are digital drawings drawn by a user on a computer display.

7. The method of claim 1 wherein the unrelated drawings are freehand drawings drawn by a user on a piece of paper.

8. The method of claim 1 wherein the unrelated drawings are outlines extracted from a picture using a computer vision program.

9. The method of claim 1 wherein rotating one of the unrelated drawings changes the 3D model.

10. The method of claim 1 wherein the unrelated drawings represent text.

11. A method that converts a plurality of first geometrical shapes and a plurality of second geometrical shapes into a 3D model by associating each one of the first geometrical shapes with one of the second geometrical shapes to create partial 3D models that are positioned together to create the 3D model.

12. The method of claim 11 wherein each one of the first geometrical shapes and the second geometrical shapes has dimension that do not match with the others.

13. The method of claim 11 wherein each one of the first geometrical shapes and the second geometrical shapes represents a top view, front view, or side view of one of the partial 3D models.

14. The method of claim 11 wherein each one of the first geometrical shapes and the second geometrical shapes is a digital drawing drawn by a user on a computer display.

15. The method of claim 11 wherein each one of the first geometrical shapes and the second geometrical shapes is a freehand drawing drawn by a user on a piece of paper.

16. The method of claim 11 wherein each one of the first geometrical shapes and the second geometrical shapes are outlines extracted from a picture using a computer vision program.

17. A method of animation that generates sequential 3D models by creating the first 3D model of the animation using a first set of unrelated drawings, and creating the last 3D model of the animation using a second set of unrelated drawings wherein converting the first 3D model to the last 3D model generates the sequential 3D models.

18. The method of claim 17 wherein the second set of the unrelated drawings is a modified version of the first set of the unrelated drawings.

19. The method of claim 17 wherein the first set of unrelated drawings and the second set of the unrelated drawings are drawn by a user.

20. The method of claim 17 wherein a user can stop the animation at any moment to select one of the sequential 3D models.
